(19) United States
(12) Patent Application Publication
(10) Pub. No.: US 2017/0131462 A1
(43) Pub. Date: May 11, 2017

(54) LIGHT GUIDE MODULE AND DISPLAY DEVICE COMPRISING SUCH LIGHT GUIDE MODULE

(71) Applicants: Le Holdings (Beijing) Co., Ltd., Beijing (CN); Le Shi Zhi Xin Electronic Technology (Tianjin) Limited, Tianjin (CN)

(72) Inventor: Xianlei Meng, Tianjin (CN)

(73) Assignees: Le Holdings (Beijing) Co., Ltd., Beijing (CN); Le Shi Zhi Xin Electronic Technology (Tianjin) Limited, Tianjin (CN)

(21) Appl. No.: 15/239,427

(22) Filed: Aug. 17, 2016

Related U.S. Application Data
(63) Continuation of application No. PCT/CN2016/086613, filed on Jun. 21, 2016.

(30) Foreign Application Priority Data
Nov. 6, 2015 (CN) 201510756865.5

(51) Int. Cl. F21V 8/00

(52) U.S. Cl. CPC G02B 6/0085; G02B 6/0091; G02B 6/0088

(57) ABSTRACT

This present disclosure discloses a light guide module and a display device including such light guide module. The light guide module includes a heat sink, the heat sink including a first heat transfer surface and a second heat transfer surface arranged at an edge of the first transfer surface; a glass light guide plate, the glass light guide plate being fixed on the first heat transfer surface and arranged in parallel to the first heat transfer surface; and a backlight bar, the backlight bar being fixed on the second heat transfer surface, and a gap being arranged between the backlight bar and the glass light guide plate. The display device includes a liquid crystal display (LCD) panel and the light guide module above, wherein the LCD panel is parallel to the glass light guide plate, and the glass light guide plate is located between the LCD panel and the first heat transfer surface. The light guide module and the display device including such light guide module provided by this present disclosure may effectively reduce the adverse effects of thermal expansion, and is beneficial for achieving design requirements of an ultra-thin complete unit and an ultra-narrow edge.

### CROSS REFERENCE TO RELATED APPLICATIONS

This application is a continuation of International Application No. PCT/CN2016/086613, filed on Jun. 21, 2016, which is based upon and claims priority to Chinese Patent Application No. 201510756865.5, filed on Nov. 6, 2015, the entire contents of which are incorporated herein by reference.

### TECHNICAL FIELD

This present disclosure relates to a field of the liquid crystal module technology, and more particularly, to a light guide module and a display device including such light guide module.

### BACKGROUND

With the increasing size of a liquid crystal display (LCD) device (e.g. LCD TV, LCD or the like), a power thereof also becomes higher and higher. To ensure a good display effect, the interior of the LCD device usually needs to be equipped with a backlight LED bar having a higher power. Such configuration directly leads to a sharp increase in a heating output, so that a problem of a light guide plate expanded by heating becomes more and more serious.

At present, a traditional light guide module usually selects a plastic light guide plate, such as a PMMA (Polymethyl Methacrylate) light guide plate or the like. However, during achieving the present disclosure, the inventor has found that, a liquid crystal module in such a structure has the following defects: on one hand, the intensity of the plastic light guide plate is extremely weak, therefore, a complete unit has to be supported by incorporating a very thick reinforced structure on a back cover. Such a design substantially increases the thickness of the complete unit so that it is difficult to achieve an ultra-thin object of the entirety. On the other hand, due to a large coefficient of thermal expansion of the plastic light guide plate, a larger deformation will occur under the influence of the heating of the backlight LED bar. Therefore, a very large gap needs to be reserved between the light guide plate and the backlight LED bar in the process of design in order to accommodate the deformation of the light guide plate, which will undoubtedly increase the width of a frame, thus and is not beneficial for achieving the design requirement of a narrow frame.

Based on the defects above, the problems, e.g. how to decrease the influence of the heat caused by the backlight LED bar on the light guide plate and reduce a potential frame shadow, the deformation of the complete unit and the like, would be urgent to be solved by manufacturers of large-size LCD devices. Therefore, it is very necessary to design a new light guide module to overcome the defects above.

### SUMMARY

Accordingly, an embodiment of the present disclosure provides a light guide module and a display device including such light guide module, aiming at overcoming the defects existing in the prior art.

A light guide module provided by the embodiment of the present disclosure includes a heat sink, the heat sink including a first heat transfer surface and a second heat transfer surface arranged at an edge of the first transfer surface; a glass light guide plate, the glass light guide plate being fixed on the first heat transfer surface and arranged in parallel to the first heat transfer surface; and a backlight bar, the backlight bar being fixed on the second heat transfer surface, and a gap being arranged between the backlight bar and the glass light guide plate.

A display device provided by the embodiments of this present disclosure includes a liquid crystal display (LCD) panel, and further includes any type of light guide module as described above, wherein the LCD panel is parallel to the glass light guide plate, and the glass light guide plate is located between the LCD panel and the first heat transfer surface.

According to the light guide module and the display device including such light guide module provided by the embodiments of this present disclosure, the glass light guide plate and the backlight bar are arranged on two heat transfer surfaces of the heat sink respectively. The expansion of the glass light guide plate is reduced due to the features of a low thermal expansion coefficient and high intensity of the glass light guide plate, thus reducing a design space and increasing the intensity of the entirety, and achieving a design object of a ultra-narrow frame and an ultra-thin complete unit. In particular, with regard to the light guide module and the display device including such light guide module provided by the embodiments of this present disclosure, since the expansion coefficient of the glass light guide plate is extremely low and the expansion capacity thereof during heating is also relatively small, it is not necessary to reverse a large gap between the glass light guide plate and the backlight bar during design, which may decrease the gap between the backlight bar and the glass light guide plate to a large extent, thus reducing the width of the frame to meet the design requirement of the narrow frame.

### BRIEF DESCRIPTION OF DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a structural schematic diagram of some embodiments of a light guide module of this present disclosure.

FIG. 2 is a structural schematic diagram of some embodiments of the light guide module of this present disclosure.

### DETAILED DESCRIPTION

The present disclosure will be described in details with reference to the embodiments hereinafter, wherein same components and parts are identified with same reference numerals. It should be noted that words “front”, “rear”, “left”, “right”, “upper” and “lower” as used in the description below refer to directions in the drawings, and words “inner” and “outer” refer to directions toward or opposite a geometric center of a specific member respectively.

### First Embodiment

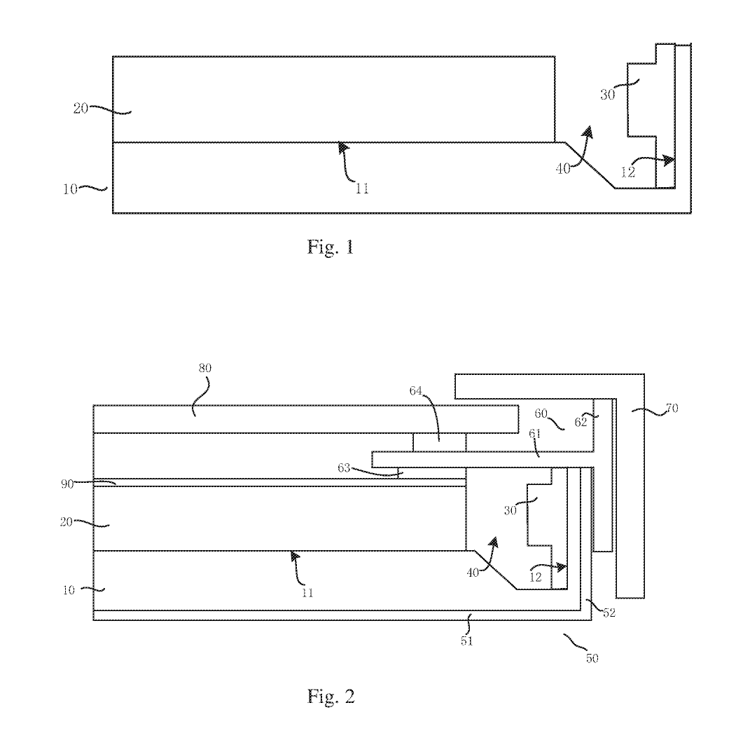

FIG. 1 shows a selective embodiment of a light guide module according to the present disclosure. As shown in FIG. 1, a light guide module includes a heat sink 10, a glass light guide plate 20 and a backlight bar 30.

The heat sink 10 includes a first heat transfer surface 11, and a second heat transfer surface 12 arranged at an edge of the first heat transfer surface 11. In one aspect, the heat sink 10 may implement heat transferring during operation; in another aspect, the glass light guide plate 20 and the backlight bar 30 are limited in position through the first heat transfer surface 11 and the second heat transfer surface 12 to achieve the better structural stability. In particular, the glass light guide plate 20 may be fixed on the first heat transfer surface 11, so that the glass light guide plate 20 is arranged in parallel to the first heat transfer surface 11; moreover, the backlight bar 30 is fixed on the second heat transfer surface 12. In the meanwhile, a gap 40 is formed between the backlight bar 30 and the glass light guide plate 20 in this design, for reserving a certain space for accommodating the heating expansion of the glass light guide plate 20.

In general, a technical solution provided by the selective embodiment of this present disclosure solves the defects existing in the traditional design by arranging the glass light guide plate 20 on the heat sink 10, so as to effectively decelerate various unfavorable consequences brought by the thermal expansion. In particular, the expansion coefficient of the glass light guide plate 20 is merely about 1/13 of that of a plastic material, and thus the heating expansion capacity thereof is much less than that of a traditional light guide plate. Therefore, during design, only a very narrow gap 40 formed between the backlight bar 30 and the glass light guide plate 20 is enough to reserve a space for accommodating the thermal expansion of the glass light guide plate 20, so as to effectively reduce a width of the frame, and being beneficial for achieving an object of an ultra-narrow edge.

### Second Embodiment

A light guide module includes a heat sink 10, a glass light guide plate 20 and a backlight bar 30. The heat sink 10 includes a first heat transfer surface 11, and a second heat transfer surface 12 arranged at an edge of the first heat transfer surface 11. In one aspect, the heat sink 10 may implement the heat transferring during operation; in another aspect, the glass light guide plate 20 and the backlight bar 30 are limited in position through the first heat transfer surface 11 and the second heat transfer surface 12 to achieve the better structural stability. In particular, the glass light guide plate 20 may be fixed on the first heat transfer surface 11, so that the glass light guide plate 20 is arranged in parallel to the first heat transfer surface 11; moreover, the backlight bar 30 is fixed on the second heat transfer surface 12. In the meanwhile, a gap 40 is formed between the backlight bar 30 and the glass light guide plate 20 according to such design.

Optionally, an angle between the first heat transfer surface 11 and the second heat transfer surface 12 is 90 degrees.

According to such design, the backlight bar 30 on the second heat transfer surface 12 is conveniently arranged in a position opposite a side edge of the glass light guide plate 20, so that a backlight utilization is improved and a display effect is promoted.

### Third Embodiment

FIG. 2 is another selective embodiment of a light guide module. As shown in FIG. 2, in this embodiment, the light guide module further includes a back cover assembly 50, wherein the back cover assembly 50 includes a first back cover 51 parallel to the first heat transfer surface 11, and a second back cover 52 connected with the first back cover 51 and parallel to the second heat transfer surface 12. The first back cover 51 is fixed on a surface of the heat sink 10 opposite the first heat transfer surface 11, and the second back cover 52 is fixed on a surface of the heat sink 10 opposite the second heat transfer surface 12. The heat transfer surface may carry away the heat caused by the bar in time. The heat transfer surface is made of a material that has a high thermal conductivity and is easily processed, such as aluminum, or aluminum-copper pipe. Optionally, the heat transfer surface is made of aluminum.

The glass light guide plate 20 is arranged on the heat sink 10, and the intensity of glass is several tens of times of that of a plastic material while being compared with the plastic material with an identical thickness. Therefore, the glass light guide plate 20 itself may play a role of back-supporting and structure-reinforcing to a large extent. Under this circumstance, any other additional reinforcing structure is not needed for the back cover assembly 50. It is necessary to only set the first back cover 51 in a flat plate structure (e.g. a stencil or hollow flat plate structure) as illustrated in FIG. 2. Even, it is available to provide no back cover. Such design may greatly reduce the thickness of the entirety, and is beneficial for achieving an object of ultra-thin design.

The glass light guide plate may be purchased from markets. For instance, the glass light guide plate may be made of Iris™ glass from Corning Incorporation. The glass light guide plate has a light transmission equivalent to that of a PMMA (Polymethyl Methacrylate) or an MS (Methyl Methacrylate-styrene Copolymer) light guide plate. Moreover, the glass light guide plate has a higher intensity, which is 23 times of that of the plastic light guide plate. The glass light guide plate further has a high heat resisting property. The deformation temperature of the plastic light guide plate is 105° C., while that of the glass light guide plate may usually exceed 600° C. Moreover, the deformation temperature of the light guide plate of this embodiment reaches 630° C. Since the expansion rate of glass is merely 1/13 of that of plastic, the glass light guide plate of this embodiment has a lower expansion rate. In this embodiment, a gap between the backlight bar and the glass light guide plate is 0.5 mm; while in other embodiments, the gap between the backlight bar and the glass light guide plate may be less than 0.5 mm.

In the selective embodiment as shown in FIG. 2, the light guide module further includes a first frame body 60, wherein the first frame body 60 is provided with a first support plate 61 parallel to the glass light guide plate 20, and an edge of the glass light guide plate 20 is clamped between the first support plate 61 and the first heat transfer surface 11. The glass light guide plate 20 is limited in position and fixed through matching the first frame body 60 with the heat sink 10. According to such design, the glass light guide plate 20 and the heat sink 10 do not need to be fixed to each other through various connecting manners like gluing, but only need to be abutted against each other, so as to effectively avoid that the usage effect of the glass light guide plate 20 is deteriorated by the deformation of solidified glue under a high temperature. In addition, various optical films 90 may also be arranged on the glass light guide plate 20 according to actual requirements.

Optionally, a first rubber gasket 63 is arranged between the first support plate 61 and the glass light guide plate 20. A buffering effect between the glass light guide plate 20 and the first frame body 60 is achieved via the first rubber gasket 63 so as to prevent damaging the glass light guide plate 20 due to the rigid collision between the glass guide plate and the first frame body.

Still optionally, the first rubber gasket 63 is fixedly connected to the first support plate 61, and the first rubber gasket 63 is abutted against the glass light guide plate 20. Due to such design, the first rubber gasket 63 is fixed on the glass light guide plate 20, which may prevent the smaller first rubber gasket 63 from falling into the other parts of the entirety during installation or maintenance to cause unfavorable consequences.

Optionally, the first frame body 60 further includes a first connecting plate 62 fixed at an edge of the first support plate 61. The light guide module further includes a second frame body 70, and the second frame body 70 is connected to the first connecting plate 62. The first frame body 60 may be configured to engage an LCD panel 80 in a module process so as to limit in position and fix the LCD panel 80.

The embodiments of the present disclosure further provide a display device. In particular, the display device includes any one type of light guide module as described above, and further includes a LCD panel 80 assembled with the light guide module in the module process. As shown in FIG. 2, the LCD panel 80 may be parallel to the glass light guide plate 20, and the glass light guide plate 20 is located between the LCD panel 80 and the first heat transfer surface 11. Since the display device of this embodiment includes the light guide module as described above, a ultrathin and ultra-narrow edge can be achieved through the design of the glass light guide plate 20.

In an optional embodiment, the light guide module further includes a first frame body 60, the first frame body 60 is provided with a first support plate 61 parallel to the glass light guide plate 20, an edge of the glass light guide plate 20 is clamped between the first support plate 61 and the first heat transfer surface 11, and an edge of the LCD panel 80 is abutted against the surface of the first support plate 61 opposite the glass light guide plate 20. A second rubber gasket 64 is arranged between the LCD panel 80 and the first support plate 61, the second rubber gasket 64 is fixedly connected with the first support plate 61, and the LCD panel 80 is abutted against the second rubber gasket 64. The buffering between the LCD panel 80 and the first support plate 61 is achieved by the second rubber gasket 64, so as to prevent damaging the LCD panel 80.

During specific application, the backlight bar 30 may form a circular structure, and the glass light guide plate 20 is located in the center of the circular structure. To be specific, the backlight bar 30 may be arranged around the glass light guide plate 20, and a gap 40 is reserved between the backlight bar 30 and the glass light guide plate 20.

### Fourth Embodiment

This embodiment provides a display device employing such light guide module provided by the embodiments of this present disclosure. The display device includes a liquid crystal display (LCD) panel and further includes the light guide module as described above, wherein the LCD panel is parallel to the glass light guide plate, and the glass light guide plate is located between the LCD panel and the first heat transfer surface.

The glass light guide plate and the backlight bar are arranged on two heat transfer surfaces of the heat sink respectively. The expansion of the glass light guide plate is reduced due to the features of the low thermal expansion coefficient and high intensity of the glass light guide plate, thus reducing the design space and increasing the intensity of the entirety to achieve a design object of an ultra-narrow frame and an ultra-thin complete unit.

### Fifth Embodiment

This embodiment provides a display device employing such light guide module provided by the embodiments of this present disclosure. The display device includes a liquid crystal display (LCD) panel and further includes the light guide module as described above, wherein the LCD panel is parallel to the glass light guide plate, and the glass light guide plate is located between the LCD panel and the first heat transfer surface. In the display device, the light guide module further includes a first frame body, wherein the first frame body is provided with a first support plat parallel to the glass light guide plate, an edge of the glass light guide plate is clamped between the first support plate and the first heat transfer surface; and an edge of the LCD panel is abutted against the surface of the first support plate opposite the glass light guide plate. According to such design, the glass light guide plate and the heat sink do not need to be fixed to each other through various connecting manners like gluing, but only need to be abutted against each other only, so as to effectively avoid that the usage effect of the glass light guide plate is deteriorated by the deformation of solidified glue under a high temperature. In addition, various optical films may also be arranged on the glass light guide plate according to actual requirements.

Optionally, a second rubber gasket is arranged between the LCD panel and the first support plate, the second rubber gasket is fixedly connected with the first support plate, and the LCD panel is abutted against the second rubber gasket. The buffering effect between the glass light guide plate and the first frame body 60 is achieved by the first rubber gasket so as to prevent damaging the glass light guide plate due to the rigid collision between the glass light guide plate and the first frame body.

Optionally, the backlight bar forms a circular structure, and the glass light guide plate is located at the center of the circular structure. The backlight bar may be arranged around the glass light guide plate and a gap is reserved between the backlight bar 30 and the glass light guide plate.

With regard to the light guide module and the display device including such light guide module provided by the embodiments of this present disclosure, since the expansion coefficient of the glass light guide plate is extremely low and the expansion thereof during heating is also relatively small, it is not necessary to reverse a large gap between the glass light guide plate and the backlight bar in the design, which may decrease the gap between the backlight bar and the glass light guide plate to a large extent, thus reducing the width of the frame, so as to meet the design requirement of the narrow frame. In the foregoing selective embodiments, the gap between the backlight bar and the glass light guide plate is less than or equal to 0.5 mm; in the display device of this embodiment, the gap between one side of the glass light guide plate opposite the backlight bar and the inner wall of the display object is less than 1 mm. In comparison, in the prior art, if a plastic light guide plate is employed, the gap between one side thereof opposite the backlight bar and the inner wall of the display object is 1 mm to 3 mm.

In addition, due to the higher intensity, the glass light guide plate may play a role for supporting and reinforcing a structure to a large extend, without needing to arrange a dedicated reinforced structure for the back cover. It is just necessary to provide a very thin flat plate structure as the back cover, or even it is unnecessary to provide the back cover, in order to reach the structure intensity as required for the entirety, thus greatly reducing the thickness of the entirety, which facilitates to achieve the design requirement of the ultra-thin entirety.

It should be finally noted that the above embodiments are for purposes of illustration and description to the technical solution of the present invention merely, but are not intended to limit the present invention. Although the present invention has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the scope of the technical solutions of various embodiments of the present invention.

What is claimed is:

1. A light guide module, including:
a heat sink, the heat sink including a first heat transfer surface, and a second heat transfer surface arranged at an edge of the first heat transfer surface;
a glass light guide plate, the glass light guide plate being fixed on the first heat transfer surface, and arranged in parallel to the first heat transfer surface; and
a backlight bar, the backlight bar being fixed on the second heat transfer surface, and a gap being arranged between the backlight bar and the glass light guide plate.

2. The light guide module according to claim 1, wherein the gap between the backlight bar and the glass light guide plate is less than or equal to 0.5 mm.

3. The light guide module according to claim 1, wherein a deformation temperature of the glass light guide plate is higher than 600° C.

4. The light guide module according to claim 1, wherein an angle between the first heat transfer surface and the second heat transfer surface is 90 degrees.

5. The light guide module according to claim 1 wherein the light guide module further includes a back cover assembly, the back cover assembly includes a first back cover parallel to the first heat transfer surface, and a second back cover connected with the first back cover and parallel to the second heat transfer surface; wherein the first back cover is fixed on a surface of the heat sink opposite the first heat transfer surface, and the second back cover is fixed on the surface of the heat sink opposite the second heat transfer surface.

6. The light guide module according to claim 5, wherein the first back cover is a flat plate.

7. The light guide module according to claim 1, wherein the light guide module further includes a first frame body, the first frame body is provided with a first support plate parallel to the glass light guide plate, and an edge of the glass light guide plate is clamped between the first support plate and the first heat transfer surface.

8. The light guide module according to claim 7, wherein a first rubber gasket is arranged between the first support plate and the glass light guide plate.

9. The light guide module according to claim 8, wherein the first rubber gasket is fixedly connected to the first support plate and the first rubber gasket is abutted against the glass light guide plate.

10. The light guide module according to claim 7, wherein the first frame body further includes a first connecting plate fixed at an edge of the first support plate; the light guide module further includes a second frame body, and the second frame body is connected to the first connecting plate.

11. The light guide module according to claim 1, wherein the glass light guide plate is abutted against the first heat transfer surface.

12. A display device, including a liquid crystal display (LCD) panel, wherein the display device further includes the light guide module according to claim 1, the LCD panel is parallel to the glass light guide plate, and the glass light guide plate is located between the LCD panel and the first heat transfer surface.

13. The display device according to claim 12, wherein the light guide module further includes a first frame body, the first frame body is provided with a first support plate parallel to the glass light guide plate, an edge of the glass light guide plate is clamped between the first support plate and the first heat transfer surface; and an edge of the LCD panel is abutted against the surface of the first support plate opposite the glass light guide plate.

14. The display device according to claim 13, wherein a second rubber gasket is arranged between the LCD panel and the first support plate, the second rubber gasket is fixedly connected with the first support plate, and the LCD panel is abutted against the second rubber gasket.

15. The display device according to claim 12, wherein the backlight bar forms a circular structure and the glass light guide plate is located at a center of the circular structure.
